(19) United States
(12) Patent Application Publication
(10) Pub. No.: US 2007/0206093 A1
(43) Pub. Date: Sep. 6, 2007

(54) Image processing apparatus, method for image processing, computer readable medium, and computer data signal

(75) Inventors: Takahiko Kuwabara, Kanagawa (JP); Noriji Kato, Kanagawa (JP); Hitoshi Ikeda, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/508,317

(22) Filed: Aug. 23, 2006

(30) Foreign Application Priority Data
Mar. 6, 2006 (JP) 2006-060263

(51) Int. Cl. H04N 7/18

(52) U.S. Cl. 348/118; 348/77

(57) ABSTRACT

An image processing apparatus including: plural detection units that detect an object from image data by detection processing of different types; inclination estimation unit that estimates inclination of the object to a reference position based on the difference between detection results of the object, the detection results being detected by each of the plural detection units; and output unit that outputs information including estimated inclination of the object.

### BACKGROUND

1. Technical Field

This invention relates to an image processing apparatus for detecting the inclination of an object such as a face from picked-up image data.

2. Related Art

In recent years, an art of detecting a region of a face from a moving image or a still image has become commercially practical. Under such present circumstances, there is increasing demand for performing various types of control and acquiring marketing information by determining the orientation of the detected face and the direction of the line of sight and detecting the attention direction of the picked-up person image.

### SUMMARY

According to an aspect of the invention, an image processing apparatus including: plural detection units that detect an object from image data by detection processing of different types; inclination estimation unit that estimates inclination of the object to a reference position based on the difference between detection results of the object, the detection results being detected by each of the plural detection units; and output unit that outputs information including estimated inclination of the object.

### BRIEF DESCRIPTION OF THE DRAWINGS

Exemplary embodiment of the present invention will be described in detail based on the following figures, wherein:

FIG. 1 is a block diagram that illustrates a configuration example of an image processing apparatus according to an exemplary embodiment of the invention;

FIG. 2 is a functional block diagram that illustrates the image processing apparatus according to the exemplary embodiment of the invention;

FIG. 3 is a schematic representation that illustrates the relationship between the difference between reference information pieces detected by the image processing apparatus according to the exemplary embodiment of the invention and face orientation; and

FIG. 4 is a schematic representation that illustrates an example of correlation functions used by the image processing apparatus according to the exemplary embodiment of the invention to detect inclination.

### DETAILED DESCRIPTION

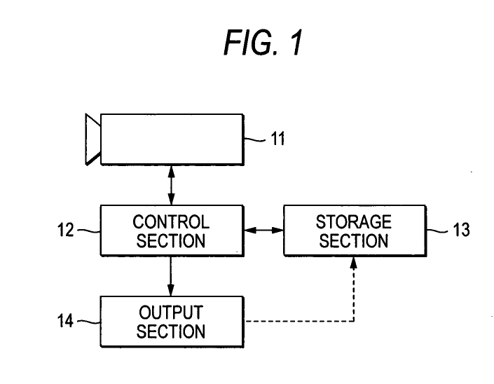

Referring now to the accompanying drawings, there is illustrated an exemplary embodiment of the invention. An image processing apparatus according to the exemplary embodiment of the invention is made up of an image pickup section 11, a control section 12, a storage section 13, and an output section 14, as illustrated in FIG. 1.

The image pickup section 11 contains an image pickup device of CCD, etc., and outputs data of an image picked up by the image pickup device to the control section 12. The control section 12 is a program control device such as a CPU and operates in accordance with a program stored in the storage section 13. The control section 12 applies processing to the image data input from the image pickup section 11 and performs processing of detecting objects by executing different types of detection processing and estimating the inclination of the object from a predetermined reference position based on the detection processing result difference. The processing is described later in detail.

The storage section 13 is made up of a storage device of RAM, ROM, etc., a hard disk, etc. It stores programs executed by the control section 12. The storage section 13 also operates as work memory of the control section 12.

The output section 14 outputs information of the object inclination estimated by the control section 12. The output section 14 is, for example, a display for displaying information of the object inclination. In another example, the output section 14 is a data logger and whenever the control section 12 outputs the estimation result of the object inclination, the output section 14 acquires date and time information from a clock section (such as a calendar chip) not illustrated and stores the date and time information and information representing the estimation result in the storage section 13.

The specific processing of the control section 12 of the exemplary embodiment will be discussed. The control section 12 of the exemplary embodiment detects the face portion of a person as an object from the image data picked up by the image pickup section 11 and detects how the face of the person is inclined from side to side (the head is shaken) using the front orientation against the image pickup section 11 as the reference position.

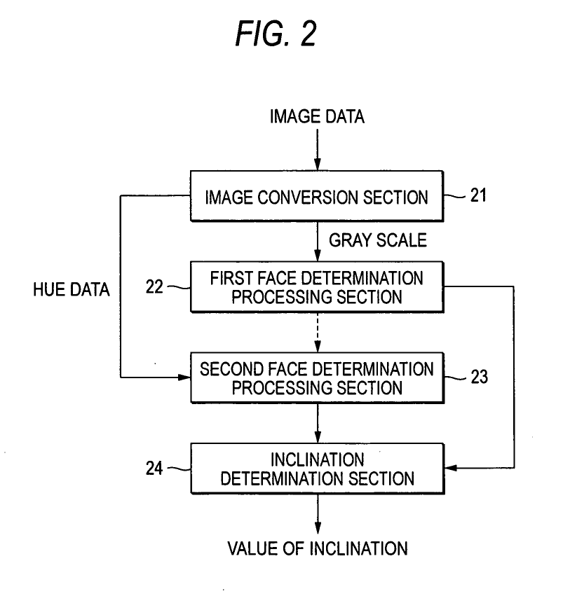

As a specific example, as the control section 12 executes the processing, the image processing apparatus of the exemplary embodiment is functionally made up of an image conversion section 21, a first face determination processing section 22, a second face determination processing section 23, and an inclination determination section 24, as illustrated in FIG. 2.

The image conversion section 21 applies processing to the image data input from the image pickup section 11 and converts the image data into gray-scale image data and outputs the gray-scale image data to the first face determination processing section 22. The image conversion section 21 also converts the image data to be processed into color space image data containing a hue component (hue data) and outputs the hue data to the second face determination processing section 23.

In the exemplary embodiment, the first face determination processing section 22 detects the object based on the contours of the object or the contours of the feature portion on the object, while the second face determination processing section 23 detects the object based on the color of the object.

This means that the first face determination processing section 22 executes processing of determining the face portion using a light and dark pattern from the gray-scale image data. This processing can adopt a pattern matching method of using a database provided by previously learning face images of samples and recognizing the face portion in image data. Here, for example, Rotation Invariant Neural Network-Based Face Detection, H. A. Rowley, S. Baluja, and T. Kanade, Proceedings of the IEEE Computer Society Conference on Computer Vision and Pattern Recognition, 1998, pp. 38-44, etc., may be used.

The first face determination processing section 22 further outputs coordinate information concerning a predetermined face part (eye, nose, mouth, etc.,) from the recognized face portion image. The coordinate information includes an intermediate point of both eyes, etc., for example. The first face determination processing section 22 outputs the coordinate information to the inclination determination section 24 as first reference point information.

The detection method of the face portion dr the face part position by the first face determination processing section 22 is not limited to the method using the pattern matching technique and the first face determination processing section 22 may detect the face portion, the face part position, etc., by using a detection method of using the four-direction plane features using information of edge gradients in the four directions of longitudinal, lateral, right slanting, and left slanting directions of the light and shade values of the pixels.

Further, the first face determination processing section 22 may use coordinate information of a rectangular region circumscribing the face portion in place of the position based on the face part as described above as the reference point of the face region, may define a predetermined position in the rectangular region (for example, the center coordinates of the rectangular region or the position which is at a quarter of the rectangular region height from the top side of the rectangular region and is the center position from side to side or the like) as the reference point, and may output the first reference point information representing the reference point to the inclination determination section 24.

The second face determination processing section 23 determines the portion of the hue previously defined as the hue of the face portion (hue of skin color) in the hue data output by the image conversion section 21. A specific processing example is as follows: A hue histogram of the skin color (skin color histogram) is generated from information of skin colors previously obtained from the face images of plural persons and is stored in the storage section 13. With each pixel of the hue data, the frequency value in the skin color histogram corresponding to the hue of the pixel is associated. A map of the frequency values corresponding to the hue data is obtained. The frequency value map becomes a two-dimensional map representing the skin color likeness. Next, in the frequency value map, a region with the frequency value greater than a predetermined threshold value is extracted as a face region. The center of gravity of the skin color (vector value resulting from dividing the total sum of vector values each provided by multiplying the coordinate value (vector value) by the frequency value by the number of pixels relating to the total sum) is computed from the extracted face region and the computation result is output to the inclination determination section 24 as second reference point information.

Here, the skin color histogram is previously generated by way of example. However, considering the fact that the skin color largely varies from one person to another, a skin color histogram may be generated using the pixel values corresponding to the face portion determined by the first face determination processing section 22 (pixel values of hue data). In this case, considering the face detection accuracy in the first face determination processing section 22, region used to generate a skin color histogram may be expanded from the contour line of the detected face portion to the outside of a predetermined number of pixels at a time and the pixel values corresponding to the expanded region may be used to generate a skin color histogram.

The inclination determination section 24 determines the orientation of the face of the picked-up person using the first reference point information output by the first face determination processing section 22 and the second reference point information output by the second face determination processing section 23. That is, the first face determination processing section 22 outputs the first reference point information determined from the face and the contours of the face part and the second face determination processing section 23 outputs the second reference point information representing the coordinates of the face center based on the face color.

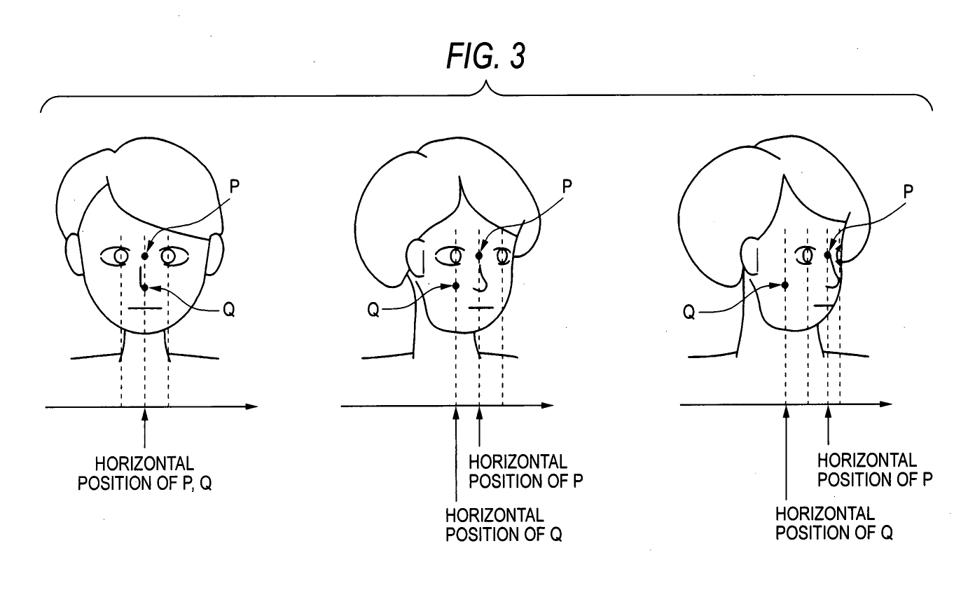

The inclination determination section 24 computes the inclination using the difference between the coordinates represented by the first reference point information and the coordinates represented by the second reference point information (relative information). That is, when the head angle changes from side to side, for example, as illustrated in FIG. 3, center position between eyes P moves in the direction of the orientation of the head; it is estimated that when the face faces the front (direction of the image pickup section 11), the position of center of gravity Q of face color in the horizontal direction does not largely change from the position in the horizontal direction of the center position between eyes P, but as the head is shaken from side to side, the position shifts in the horizontal direction from the center position between eyes P.

Likewise, it is estimated that when the head direction changes in the up and down direction, the vertical direction shift of each of the coordinate positions represented by the first reference point information and the second reference point information also changes.

Then, in the exemplary embodiment, a correlation function between the face inclination (for example, side-to-side angle) and the relative information is previously obtained experimentally. The correlation function may be found by a method of approximating the measurement results of samples according to a polynomial and optimizing the coefficient of the polynomial according to a least squares method or a machine learning system such as a neural network, etc., may be used.

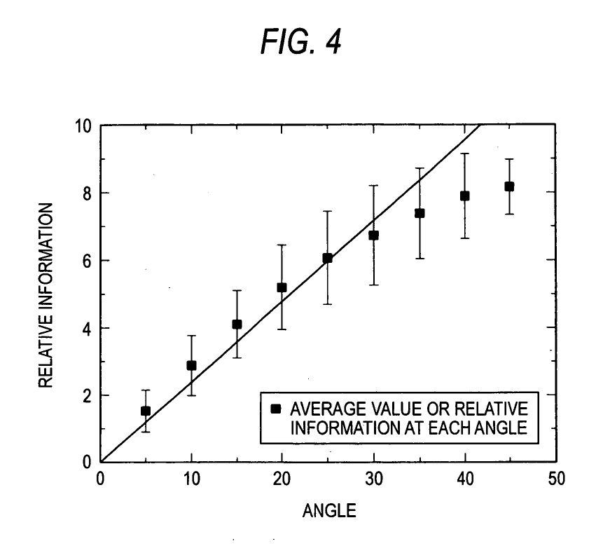

FIG. 4 illustrates an example of experimentally determining the angle value representing the side-to-side face inclination relative to the horizontal direction difference between the coordinate positions represented by the first reference point information and the second reference point information (side-to-side relative information). In FIG. 4, the side-to-side relative information when the face angle is actually changed every five degrees is measured using plural samples and the average value at each angle is represented by a filled square and the error range estimated from the measurement result variance at each angle is represented by a bar. The linear approximate result of the information is indicated by the solid line. A higher-order polynomial may be used for approximation or a polygonal (broken) line may be used for approximation to obtain a correlation function rather than linear approximation.

The inclination determination section 24 computes the difference between the first reference point information output by the first face determination processing section 22 and the second reference point information output by the second face determination processing section 23, finds the value of the inclination angle corresponding to the relative information obtained by the computing according to the experimentally obtained correlation function, and outputs the found inclination angle value.

To compute the relative information, for example, the relative information representing the side-to-side inclination of the head obtained from the horizontal direction coordinate value difference between the first reference point information and the second reference point information (horizontal relative information) and the relative information representing the up-and-down inclination of the head obtained from the vertical direction coordinate value difference between the first reference point information and the second reference point information (vertical relative information) may be computed separately and correlation functions previously obtained experimentally about the horizontal relative information and the vertical relative information (horizontal correlation function and vertical correlation function) may be used to separately find the face inclination in the horizontal direction (angle of head shake) and the face inclination in the vertical direction.

According to an aspect of the embodiment, when an image of a person is picked up in the image pickup section 11, the control section 12 detects the contours of two eyes of the feature portions in the face of the person, generates the first reference point information representing the coordinates of the center point of the left and right eyes, uses a predetermined skin color histogram to detect the position of the center of gravity of the skin color, and generates the second reference point information representing the position of the center of gravity. The control section 12 generates the difference between the coordinate positions represented by the first reference point information and the second reference point information (relative information).

The control section 12 also experimentally determines and stores a correlation function associating the relative information and face angle information with each other beforehand and uses the correlation function to acquire the face angle information corresponding to the generated relative information. Then, the control section 12 outputs the acquired face angle information.

Accordingly, for example, if the image pickup section 11 is placed on a commodity exhibit rack in a store, which commodity a customer pays attention to can be known according to the relationship between the face angle and the exhibited commodity position. In the exemplary embodiment, continuous angle values are detected, so that the detection accuracy as to which commodity a customer pays attention to can be improved. To use the image processing apparatus for detecting the face angle, even if the lighting orientation changes, the face angle can be stably detected and the robustness can be improved.

The actual sales results are acquired from a POS (point of sales) system, etc., and are compared, whereby the commodities can be classified into those not sold although attention is paid to them or those sold although no attention is paid to them.

Further, for example, the attributes such as the gender and the age of each person are determined from the relative positions between face parts obtained from the four-direction plane features from the face image and are recorded together with the detection result, whereby the data can be provided for statistical processing as to persons of what gender and age bracket pay attention to what commodities.

In the description made so far, the person face is adopted as the object by way of example. However, for example, the automobile orientation, etc., can be estimated in a similar manner. For example, the following processing can be performed: The contours of a car are acquired from the edges of image data and separately the headlight positions are detected and the traveling direction of the car is estimated from the difference between the detection results of the contours and the headlight positions.

According to an aspect of the embodiment, attention is focused on the fact that there is correlation between the relationship between the detection results produced by plural detection methods and the inclination of the object and a correlation function representing the correlation is estimated and the inclination of the object is estimated according to the correlation function, so that the inclination can be detected as continuous values and the use field can be enlarged.

What is claimed is:

1. An image processing apparatus comprising:
a plurality of detection units that detect an object from image data by detection processing of different types;
inclination estimation unit that estimates inclination of the object to a reference position based on the difference between detection results of the object, the detection results being detected by each of the plurality of detection units; and
output unit that outputs information including estimated inclination of the object.

2. The image processing apparatus as claimed in claim 1 wherein the object is a face of a person.

3. A method for image processing method comprising:
detecting an object from image data;
determining difference between detection results of the objection;
estimating inclination of the object to a reference position based on determined difference; and
outputting information including estimated inclination of the object.

4. A computer readable medium storing a program causing a computer to execute a process for detecting inclination of an object,
the process comprising:
detecting the object from image data by detection processing of different types;
estimating the inclination of the object to a reference position based on the difference between detection results of the object, the detection results being detected by each of the plurality of detection unit; and
outputting information including estimated inclination of the object.

5. A computer data signal embodied in a carrier wave for enabling a computer to perform a process for detecting inclination of an object,
the process comprising:
detecting the object from image data by detection processing of different types;
estimating the inclination of the object to a reference position based on the difference between detection results of the object, the detection results being detected by each of the plurality of detection unit; and
outputting information including estimated inclination of the object.
